(19) United States
(12) Patent Application Publication
(10) Pub. No.: US 2009/0079203 A1
(43) Pub. Date: Mar. 26, 2009

(54) Door latching device

(76) Inventor: Meng Feng Huang, Changhua Hsien (TW)

Correspondence Address: CHARLES E. BAXLEY, ESQUIRE, 90 JOHN STREET, SUITE 309, NEW YORK, NY, 10038, US

(21) Appl. No.: 11/903,546

(22) Filed: Sep. 21, 2007

(51) Int. Cl. E05C 1/08

(52) U.S. Cl. 292/64

(57) ABSTRACT

A door latching device includes a hook member, a housing, a slider slidably received in the housing and having one end for being depressed by the hook member, a latch member having a pivot axle rotatably engaged with the housing and pivotally coupled to the slider for allowing the latch member to be rotated relative to the housing by the slider, and a pawl rotatably attached to the slider for selectively positioning the slider at an intermediate position of the chamber of the housing and for maintaining the latch member at the second position which is disengaged from the hook member and for allowing the door panel to be easily anchored to or disengaged from the wall member without bending down the users' bodies.

### BACKGROUND OF THE INVENTION

1. Field of the Invention

The present invention relates to a door latching device, and more particularly to a door latching device for releaseably attaching or anchoring or positioning a door panel to a wall member, and having a structure for allowing the door panel to be easily anchored or positioned to the wall member and to be easily disengaged or released from the wall member without bending down the users' bodies and without hand contacting or engaging with latches and hook members.

2. Description of the Prior Art

Typical door panels are required to be attached or anchored or positioned or retained to a wall member with various kinds of retaining or locking or latching devices, in order to retain and to position the door panels at an open position relative to the wall member.

For example, U.S. Pat. No. 4,302,864 to Morita discloses one of the typical door stop and latching device combinations comprising an outwardly extending arm member attached to the door panel, and a pivotal latching mechanism attached to the wall member for engaging with or for acting with the outwardly extending arm member that is attached to the door panel, and for releaseably retaining or locking or latching the door panels to the wall member at the open position.

However, the door panel has to be quickly moved away from the wall member after the pivotal latching mechanism is released from the outwardly extending arm member, otherwise the pivotal latching mechanism may be hooked or latched to the outwardly extending arm member again and may not be opened when the door panel is slowly moved away from the wall member.

U.S. Pat. No. 7,201,409 to Adachi et al discloses another typical retracting locking mechanism comprising a striker attached to one of the openable unit and a fixed unit, and a catcher attached to the other of the openable unit and the fixed unit and having an inner part and an outer part for housing the inner part, and a dampening device for providing a dampening force to the retreating movement of the inner part caused by a coil spring.

However, the typical retracting locking mechanism includes a complicated structure that may not be easily manufactured or assembled.

The present invention has arisen to mitigate and/or obviate the afore-described disadvantages of the conventional door latching devices.

### SUMMARY OF THE INVENTION

The primary objective of the present invention is to provide a door latching device for releaseably attaching or anchoring or positioning a door panel to a wall member, and having a structure for allowing the door panel to be easily anchored or positioned to the wall member and to be easily disengaged or released from the wall member.

The other objective of the present invention is to provide a door latching device for releaseably attaching or anchoring or positioning the door panel to the wall member without bending down their bodies to hook or to engage the latch with the hook member or without hand contacting or engaging with the latch.

In accordance with one aspect of the invention, there is provided a door latching device comprising a hook member, a housing including a first end and a second end, and including a chamber formed therein and opened through the second end of the housing, a slider slidably received and engaged in the chamber of the housing and movable between an outer portion and an inner portion of the chamber of the housing, and including a first end extendible out of the chamber of the housing for being depressed by the hook member, and including a second end received in the chamber of the housing, a latch member including a pivot axle rotatably engaged with the housing for allowing the latch member to be rotated relative to the housing with the pivot axle and between a first position engageable with the hook member and a second position disengaged from the hook member, and including a shaft pivotally coupled to the slider with an arm and for allowing the latch member to be rotated relative to the housing by the slider, a spring biasing device for biasing the slider toward the outer portion of the chamber of the housing, and for biasing the latch member to selectively with the hook member, and a pawl rotatably attached to the slider for selectively engaging with the housing and for selectively positioning the slider at an intermediate position of the chamber of the housing and for maintaining the latch member at the second position which is disengaged from the hook member.

The housing includes a compartment formed therein, and includes a first actuator and a second actuator provided in the compartment of the housing, and the pawl includes a first engaging member and a second engaging member for selectively engaging with the first and the second actuators of the housing and for selectively anchoring and positioning the slide at the intermediate position of the chamber of the housing.

The pawl includes a spindle extended therefrom for rotatably engaging with the slider. The arm includes a pivot pin pivotally coupled to the slider, and includes an orifice formed therein for rotatably engaging with the shaft of the latch member.

The slider includes a space formed therein and formed by two side walls for receiving the arm, and includes an aperture formed in each of the side walls for engaging with the pivot pin of the arm. The arm includes a channel formed between two spring blades, and the pivot pin is extended from each of the spring blades.

The slider includes a pad attached thereto for softly engaging with the hook member and for preventing the hook member from being damaged by the slider.

The pivot axle is provided on a first end of the latch member, and the latch member includes at least one bent segment bent from the pivot axle, and the shaft is bent from the bent segment and offset from the pivot axle for engaging with the arm and for pivotally coupling the latch member to the arm. The bent segment is perpendicular to the pivot axle.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial cross sectional view of a door latching device in accordance with the present invention;

FIG. 2 is a partial exploded view of the door latching device;

FIG. 3 is another partial exploded view of the door latching device;

FIG. 4 is a further partial exploded view of the door latching device;

FIGS. 5, 6 and 7 are partial cross sectional views similar to FIG. 1 illustrating the operation of the door latching device;

FIG. 8 is a partial plan view illustrating the operation of the door latching device; and

FIGS. 9, 10, 11, 12 and 13 are partial plan views similar to FIG. 8 illustrating the operation of the door latching device.

### DETAILED DESCRIPTION OF THE PREFERRED EMBODIMENT

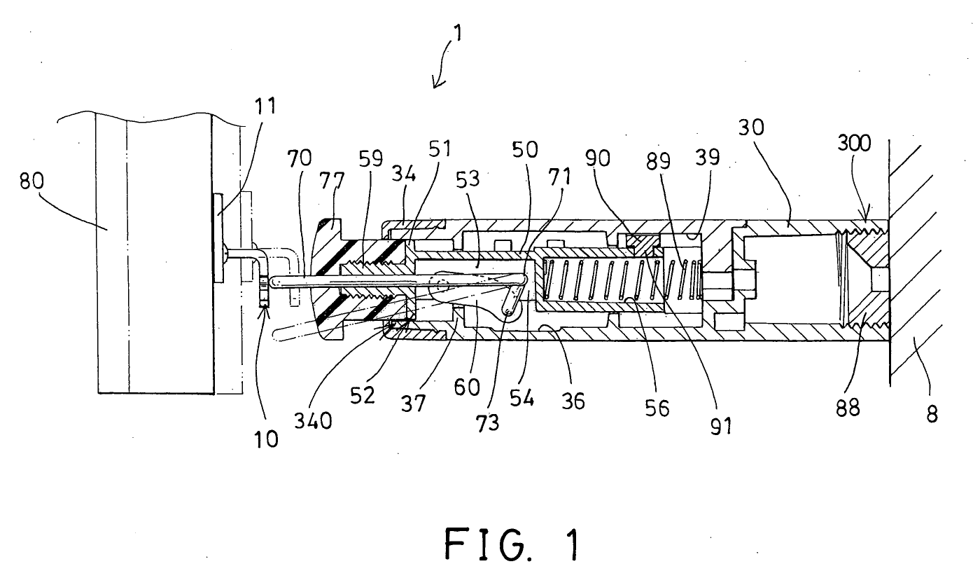

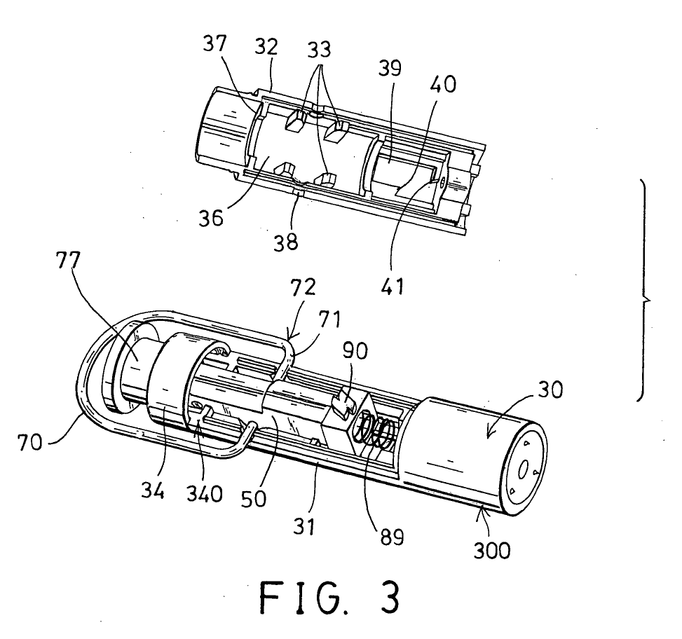

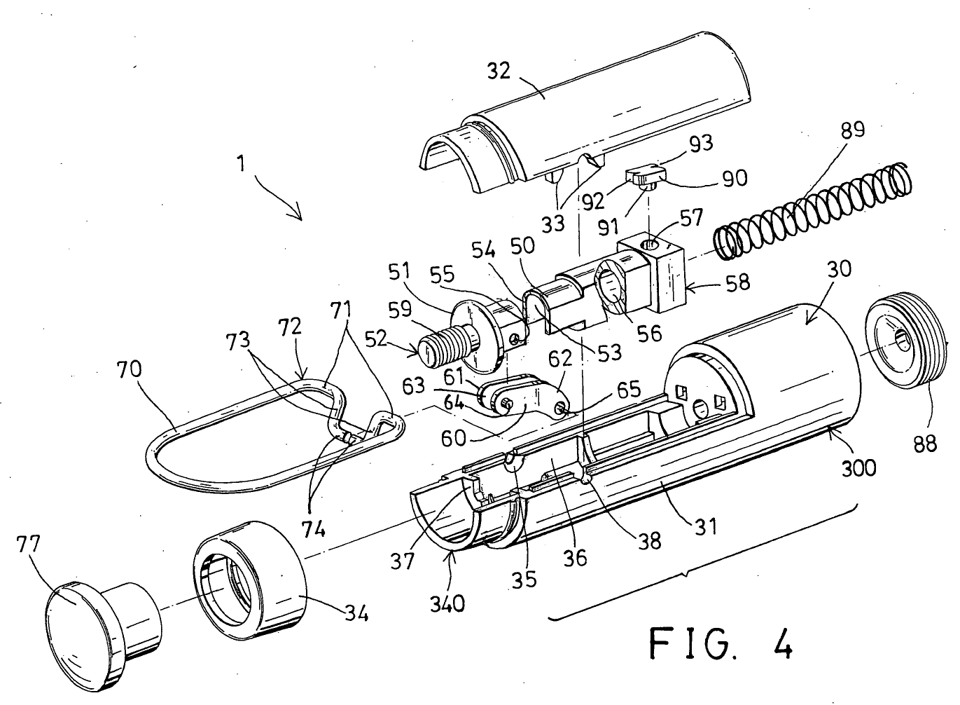

Referring to the drawings, and initially to FIGS. 1-2 and 5-7, a door latching device in accordance with the present invention comprises a hook member 10 including a seat 11 for attaching or securing to an openable member 80, such as a wall member 8 or a door panel 80 with such as latches or fasteners (not shown), and a housing 30 for securing at one end or first end 300 to the other openable member 8 such as the door panel 80 or the wall member 8 with such as latches or fasteners 88 (FIGS. 1, 4-7). The housing 30 may include two housing members 31, 32 to be secured together with such as fasteners or catches 33 (FIGS. 3, 4) and/or with a retaining ring 34 at the other end or second end 340 thereof, for example, the lower housing member 31 may include one or more depressions 35 formed therein (FIG. 4) for receiving the catches 33 and for anchoring the housing members 31, 32 together.

The housing 30 may include a chamber 36 formed therein and opened through the other end 340 of the housing 30, and may further include an inner peripheral flange 37 extended radially into the chamber 36 thereof, and includes two orifices 38 formed therein, such as formed in the housing members 31, 32 and aligned with each other, and includes a compartment 39 formed therein, such as formed in the upper housing member 32 (FIGS. 3 and 5-13), and includes two actuators 40, 41 formed or provided or extended in the compartment 39 of the upper housing member 32 or of the housing 30 and disposed oppositely for forming a substantially N-shaped structure for the compartment 39 of the upper housing member 32 or of the housing 30, in which the actuator 40 is located closer to the inner peripheral flange 37 and the orifices 38 of the housing 30 than the other actuator 41.

A slider 50 is slidably received or engaged in the chamber 36 of the housing 30, and includes an enlarged stop 51 extended radially and outwardly from one end or front end 52 thereof for engaging with the inner peripheral flange 37 of the housing 30 and for limiting the slider 50 to slide or to move relative to the housing 30, and includes a space 53 formed in the middle portion of the slider 50 and formed or defined by two side walls 54 for pivotally receiving or engaging or attaching an arm 60 therein. For example, the slider 50 includes an aperture 55 formed in each of the side walls 54, and the arm 60 includes two spring blades 61 coupled together at one end portion 62, and a channel 63 formed between the spring blades 61, and a pivot pin 64 extended from each of the spring blades 61 for engaging onto the aperture 55 of the side walls 54 of the slider 50 and for pivotally coupling the arm 60 to the slider 50, and the arm 60 includes an orifice 65 formed in the end portion 62.

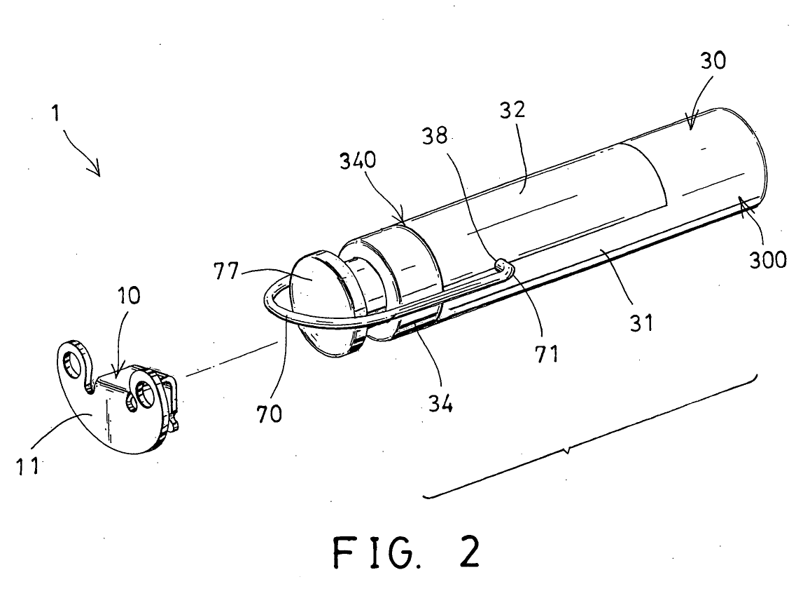

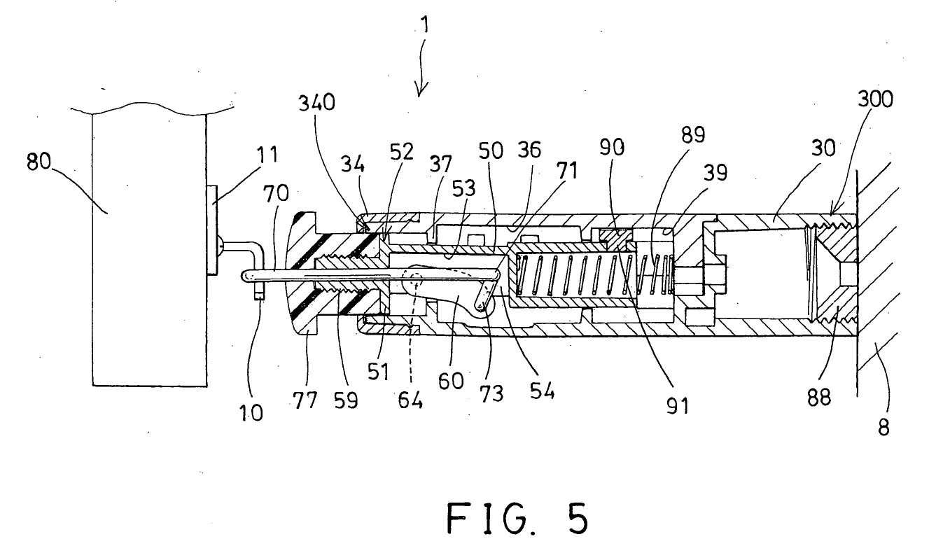

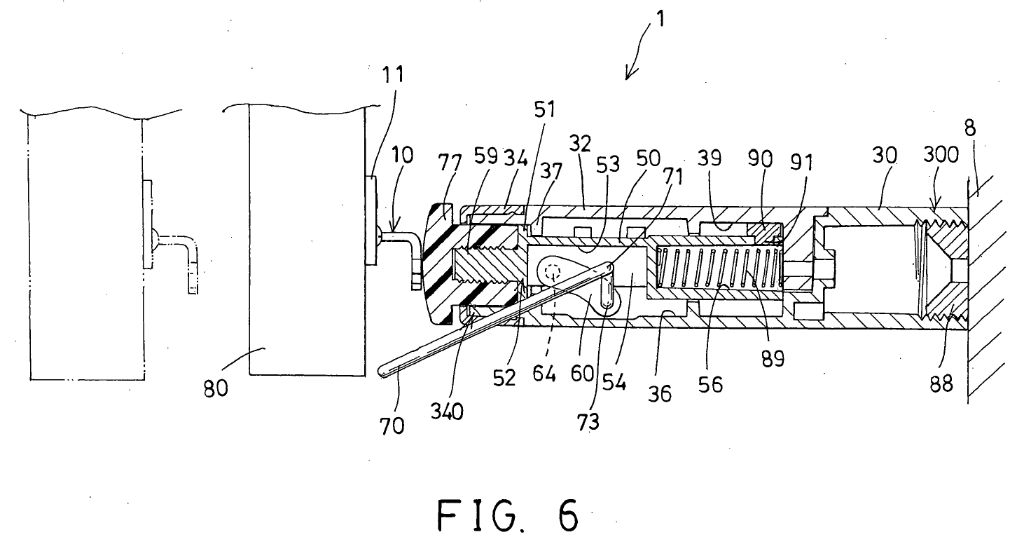

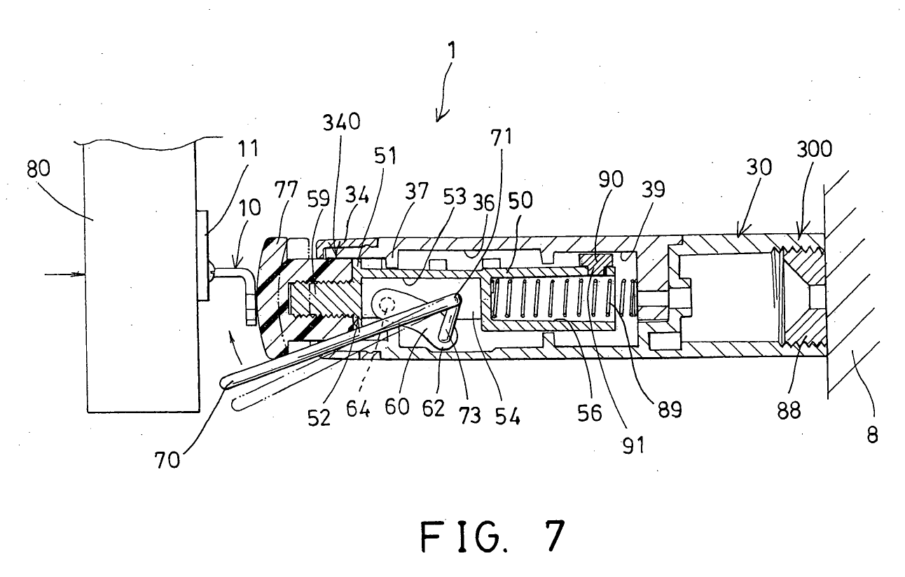

A ring-shaped tongue or latch member 70 includes a pivot axle 71 formed or provided on one end 72 thereof for rotatably attaching or engaging into the orifices 38 of the housing 30 (FIGS. 2, 3) and for allowing the latch member 70 to be rotated relative to the housing 30 with the pivot axle 71, and includes one or more (such as two) bent segments 73 bent from the pivot axle 71 and perpendicular to the pivot axle 71, and further one or more (such as two) shafts 74 bent from the bent segments 73 respectively and perpendicular to each other and directed toward each other and offset from the pivot axle 71 for engaging into the orifice 65 of the arm 60 and for pivotally coupling the arm 60 to the latch member 70, and for rotating the latch member 70 relative to the housing 30 between a position engageable with the hook member 10 (FIG. 5) and another position disengaged from the hook member 10 (FIGS. 6, 7) when the arm 60 and the slider 50 are moved relative to the housing 30, and thus for allowing the latch member 70 to be selectively engaged with the hook member 10 (FIG. 5) or disengaged from the hook member 10 (FIGS. 6, 7).

The slider 50 includes a compartment 56 formed therein (FIGS. 4-7) for receiving a spring biasing means or member 89 which is engaged with the housing 30 or engaged between the housing 30 and the slider 50 for biasing or forcing or moving the slider 50 toward the other end 340 of the housing 30 and for rotating the latch member 70 relative to the housing 30 to engage with the hook member 10 (FIG. 5). The slider 50 includes a cavity 57 formed in the rear end or other end portion 58 thereof, and includes an outer thread or fastening device 59 formed or provided on the front end or one end portion 52 thereof for threading or attaching or securing a soft or resilient pad 77 which may be softly engaged with the hook member 10 (FIGS. 6, 7) for preventing the hook member 10 from being stricken or damaged by the slider 50.

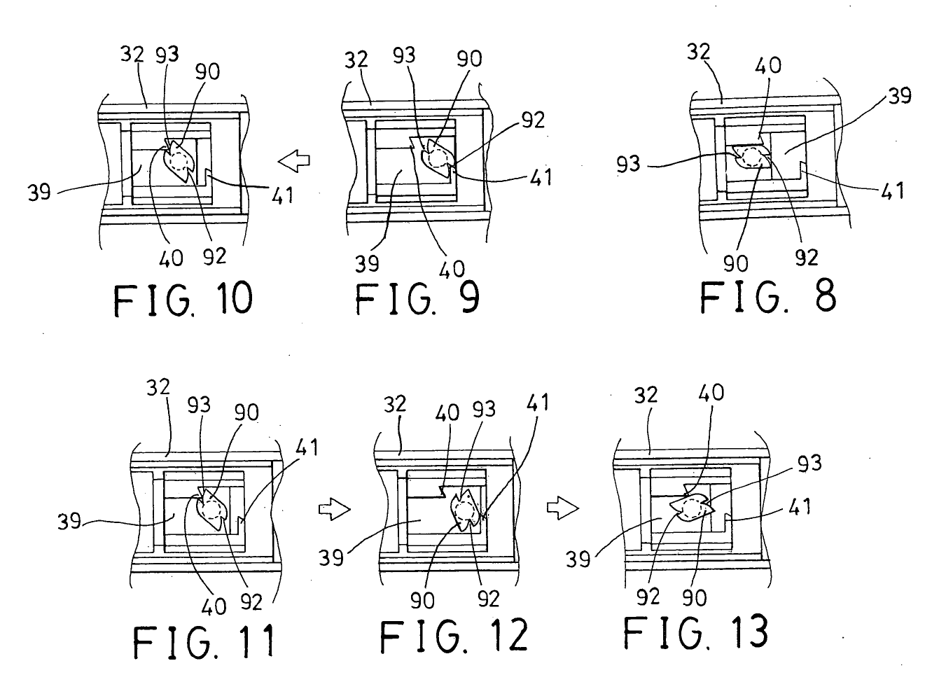

An anchor member or pawl 90 is rotatably engaged in the compartment 39 of the upper housing member 32 or of the housing 30 (FIGS. 5-13) and includes a spindle 91 extended therefrom for engaging into the cavity 57 of the slider 50 for rotatably engaged or attached onto the slider 50 and for selectively engaging with the actuators 40, 41 of the housing 30 (FIGS. 8-13) and for limiting or controlling the slider 50 to move or to slide relative to the housing 30, and thus for controlling the latch member 70 to selectively engage with the hook member 10 or to be selectively disengaged from the hook member 10. For example, the pawl 90 includes two opposite notches or engaging members 92, 93 formed or provided therein for selectively engaging with the actuators 40, 41 of the housing 30 and for selectively anchoring or positioning the slider 50 at the required or selected position relative to the housing 30.

In operation, as shown in FIGS. 5 and 8, at the beginning, the pawl 90 is disengaged from the actuators 40, 41 of the housing 30 and the spring member 89 may bias or force or move the slider 50 toward the one end 340 of the housing 30 in order to rotate the latch member 70 relative to the housing 30 and to engage with the hook member 10. As shown in FIG. 6, when the door panel 80 is moved toward the wall member 8, the hook member 10 may be forced to engage with the pad 77 of the slider 50 and may force the slider 50 to move into the inner portion or position of the chamber 36 of the housing 30 or to move against the spring member 89 or to move toward the one end or first end 300 of the housing 30, and thus may force the latch member 70 to rotate relative to the housing 30 with or about the pivot axle 71, and thus to selectively disengage the latch member 70 from the hook member 10.

At this moment, as shown in FIGS. 9-10, one of the engaging members 92 of the pawl 90 may first be forced to engage with one of the actuators 41 of the housing 30 when the slider 50 is forced to move against the spring member 89 and to move toward the one end or first end 300 of the housing 30 or to move into the inner portion or position of the chamber 36 of the housing 30, and the pawl 90 may then be slightly rotated relative to the housing 30 by the engagement of the engaging member 92 of the pawl 90 and the actuator 41 of the housing 30 (FIG. 9). When the door panel 80 is released or is moved away from the wall member 8, the spring member 89 may bias or force or move the slider 50 toward the one end 340 of the housing 30 and may force the other engaging member 93 of the pawl 90 to engage with the other actuator 40 of the housing 30 (FIG. 10), and to limit the slider 50 to move relative to the housing 30, and to prevent the slider 50 from being moved completely toward the outer end portion 340 of the housing 30, or to position the slider 50 at an intermediate position of the chamber 36 of the housing 30, and thus to maintain the latch member 70 at a disengagement position from the hook member 10 (FIG. 6).

As shown in FIGS. 7 and 11-13, when the door panel 80 is moved toward the wall member 8 again, the hook member 10 may be forced to engage with the pad 77 of the slider 50 and may force the slider 50 to move into the inner portion or position of the chamber 36 of the housing 30 again or to move against the spring member 89 or to move toward the one end or first end 300 of the housing 30 again, and thus may force the engaging member 92 of the pawl 90 toward the actuator 41 of the housing 30 again (from FIG. 11 to FIG. 12). However, due to the tilting or rotated position of the pawl 90 relative to the housing 30, the actuator 41 may cause the pawl 90 to further rotate relative to the housing 30 (FIG. 12), and the other actuator 40 may then further rotate the pawl 90 relative to the housing 30 (FIGS. 13, 8) when the door panel 80 is further released or is moved away from the wall member 8 and when the spring member 89 bias or force the slider 50 to move toward the one end 340 of the housing 30, at this moment, the latch member 70 may be forced to rotate relative to the housing 30 and to engage with the hook member 10 again (from FIG. 7 to FIG. 5).

Accordingly, in operation, the user is simply required to move the door panel 80 toward the wall member 8 and to force or depress the hook member 10 onto the pad 77 of the slider 50 and against the spring member 89, and thus to actuate and to disengage the latch member 70 from the hook member 10 (FIGS. 5, 6) and to allow the door panel 80 to be easily and readily and quickly disengaged from the wall member 8. The user is also simply required to move the door panel 80 toward the wall member 8 and to force or depress the hook member 10 onto the pad 77 of the slider 50 and against the spring member 57 again, in order to actuate the pawl 90 or to disengage the pawl 90 from the actuators 40, 41 of the housing 30 and to allow the door panel 80 to be easily and readily and quickly anchored and secured to the wall member 8 with the latch member 70.

Accordingly, the door latching device in accordance with the present invention may be provided for releasably attaching or anchoring or positioning a door panel to a wall member, and having a structure for allowing the door panel to be easily anchored or positioned to the wall member and to be easily disengaged or released from the wall member without bending down the users' bodies and without hand contacting or engaging with latches and hook members.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A door latching device comprising:
a hook member,
a housing including a first end and a second end, and including a chamber formed therein and opened through said second end of said housing,
a slider slidably received and engaged in said chamber of said housing and movable between an outer portion and an inner portion of said chamber of said housing, and including a first end extendible out of said chamber of said housing for being depressed by said hook member, and including a second end received in said chamber of said housing,
a latch member including a pivot axle rotatably engaged with said housing for allowing said latch member to be rotated relative to said housing with said pivot axle and between a first position engageable with said hook member and a second position disengaged from said hook member, and including a shaft pivotally coupled to said slider with an arm and for allowing said latch member to be rotated relative to said housing by said slider,
means for biasing said slider toward said outer portion of said chamber of said housing, and for biasing said latch member to selectively with said hook member, and
a pawl rotatably attached to said slider for selectively engaging with said housing and for selectively positioning said slider at an intermediate position of said chamber of said housing and for maintaining said latch member at said second position which is disengaged from said hook member.

2. The door latching device as claimed in claim 1, wherein said housing includes a compartment formed therein, and includes a first actuator and a second actuator provided in said compartment of said housing, and said pawl includes a first engaging member and a second engaging member for selectively engaging with said first and said second actuators of said housing and for selectively anchoring and positioning said slide at the intermediate position of said chamber of said housing.

3. The door latching device as claimed in claim 2, wherein said pawl includes a spindle extended therefrom for rotatably engaging with said slider.

4. The door latching device as claimed in claim 1, wherein said arm includes a pivot pin pivotally coupled to said slider, and includes an orifice formed therein for rotatably engaging with said shaft of said latch member.

5. The door latching device as claimed in claim 4, wherein said slider includes a space formed therein and formed by two side walls for receiving said arm, and includes an aperture formed in each of said side walls for engaging with said pivot pin of said arm.

6. The door latching device as claimed in claim 4, wherein said arm includes a channel formed between two spring blades, and said pivot pin is extended from each of said spring blades.

7. The door latching device as claimed in claim 1, wherein said slider includes a pad attached thereto for softly engaging with said hook member and for preventing said hook member from being damaged by said slider.

8. The door latching device as claimed in claim 1, wherein said pivot axle is provided on a first end of said latch member, and said latch member includes at least one bent segment bent from said pivot axle, and said shaft is bent from said at least one bent segment and offset from said pivot axle for engaging with said arm and for pivotally coupling said latch member to said arm.

9. The door latching device as claimed in claim 8, wherein said at least one bent segment is perpendicular to said pivot axle.
